(19) United States
(12) Patent Application Publication
(10) Pub. No.: US 2014/0118399 A1
(43) Pub. Date: May 1, 2014

(54) DISTORTION CORRECTION FOR VISUAL OBJECTS IN MOTION

(71) Applicant: QUALCOMM MEMS TECHNOLOGIES, INC., San Diego, CA (US)

(72) Inventors: Mark Milenko Todorovich, San Diego, CA (US); Hemang Jayant Shah, San Diego, CA (US); Zhanpeng Feng, Fremont, CA (US); Muhammed Ibrahim Sezan, Los Gatos, CA (US)

(73) Assignee: QUALCOMM MEMS TECHNOLOGIES, INC., San Diego, CA (US)

(21) Appl. No.: 13/662,227

(22) Filed: Oct. 26, 2012

(51) Int. Cl. G09G 5/00

(52) U.S. Cl. 345/634

(57) ABSTRACT

This disclosure provides implementations of systems, devices, components, computer products, methods, and techniques for correcting or compensating for moving visual object distortions. In one aspect, a method includes combining image data from a first frame with image data from a second frame to generate a fused image frame. Additionally or alternatively, the method can include applying a shear transformation to the image data in the first frame to generate a sheared image frame. One of, or a combination of, the fused image frame and the sheared image frame may be displayed as a pre-distorted image frame so that, when viewed on the display, the pre-distorted image frame compensates for distortion that can otherwise be perceived by a user when viewing the displayed moving visual object.

### TECHNICAL FIELD

This disclosure relates generally to image processing, and more specifically to correcting or compensating for visual distortion that can otherwise be perceived by a viewer when a displayed visual object moves across a display.

### DESCRIPTION OF THE RELATED TECHNOLOGY

A display, such as an interferometric modulator (IMOD) display, a liquid crystal display (LCD) display, or a light-emitting diode (LED) display, generally includes an array of display elements also referred to as pixels. Some such displays can include arrays of hundreds, thousands, or millions of pixels arranged in hundreds or thousands of rows and hundreds or thousands of columns. For example, some such displays include 1024×768 arrays, 1366×768 arrays, or 1920×1080 arrays, where the first number indicates the width of the display in a number of columns and the second number indicates the height of the display in a number of rows. Each pixel, in turn, can include one or more sub-pixels. For example, each pixel can include a red sub-pixel, a green sub-pixel, and a blue sub-pixel that emit red, green, and blue light, respectively. The three colors can be selectively combined to produce and display a variety of colors. Each red sub-pixel, green sub-pixel, and blue-sub-pixel, in turn, also can include an array of one or more sub-sub-pixels that can be individually or otherwise selectively activated for discretely adjusting an intensity of each of the constituent colors—red, green, and blue—emitted by the pixel.

As used herein, the term IMOD or interferometric light modulator refers to a device that selectively absorbs or reflects light using the principles and physics of optical interference and optical absorption. In some implementations, an IMOD may include a pair of conductive plates, one or both of which may be transparent or reflective, wholly or in part, and capable of relative motion upon application of an appropriate electrical signal. In an implementation, one plate may include a stationary layer (for example, a thin film optical absorber) deposited on a substrate and the other plate may include a reflective membrane separated from the stationary layer by an air gap. The position of one plate in relation to another can change the optical interference of light incident on the IMOD. IMOD devices have a wide range of applications, and are anticipated to be used in improving existing products and creating new products, especially those with display capabilities.

While the refresh rates and processing capabilities of displays has increased significantly in recent years, displaying moving visual objects across a display has continued to present challenges for display manufactures. For example, depending on the drive or scanning scheme used and the velocity of a moving visual object to be displayed, certain unintended and undesirable visual distortions can be displayed or otherwise perceived by viewers, detracting from an otherwise pleasing image or video experience.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method. The method includes obtaining a first image frame including first image data including image data to be displayed for a moving visual object, and obtaining a second image frame including second image data including image data to be displayed for the moving visual object. The method additionally includes one or both of: combining the first image data with the second image data to generate a fused image frame including fused image data; and applying a shear transformation to the first image data to generate a sheared image frame including sheared image data. The method further includes generating a pre-distorted image frame using one or both of the fused image frame and the sheared image frame.

In some implementations, the first image frame is a current image frame and the second image frame is a next image frame. In some such implementations, combining the first image data with the second image data includes, for a given pixel value, summing a first contribution from the first frame with a second contribution from the second image frame. In some implementations, the first contribution from the first frame is equal to a first weight multiplied by the pixel value for the pixel of the first frame and the second contribution from the second frame is equal to a second weight multiplied by the pixel value for the pixel of the second frame.

In some implementations, the first and second weights are functions that depend in which line of the display the pixel is located. In some such implementations, the method further includes determining a velocity of the visual object, wherein the first and second weights are functions that depend on the determined velocity.

In some implementations, the method further includes determining a displacement of the visual object between the first image frame and the second image frame. In some such implementations, applying a shear transformation to the first image data includes, for a given pixel value in position (m, n) of the sheared frame, where m is the column number of the corresponding pixel and n is the scan line or row number of the corresponding pixel: determining the value of the pixel at position (m−k*d, n) of the first frame, where d is the determined displacement of the image data in line n and k is a multiplier, and using the determined pixel value in the first frame at position (m−k*d, n) as the pixel value for position (m, n) of the sheared frame.

In some implementations, generating the pre-distorted image frame includes summing a first contribution from the fused image frame with a second contribution from the sheared image frame. In some such implementations, the first contribution from the fused image frame is equal to a first weight multiplied by the pixel value for the pixel of the fused image frame, and the second contribution from the sheared image frame is equal to a second weight multiplied by the pixel value for the pixel of the sheared image frame.

Another innovative aspect of the subject matter described in this disclosure can be implemented in a device. The device includes a display, one or more display drivers for scanning lines of the display based on image data in image frames received by the display drivers, and a buffer for buffering image frames. The device additionally includes one or more processors configured to: obtain a first image frame including first image data, the first image data for the first image frame including image data to be displayed for a moving visual object, and obtain a second image frame including second image data, the second image data for the second image frame including image data to be displayed for the moving visual object. The one or more processors are additionally configured to combine the first image data with the second image data to generate a fused image frame including fused image data. The one or more processors also are configured to apply a shear transformation to the first image data to generate a sheared image frame including sheared image data. The one or more processors are further configured to generate a pre-distorted image frame using one or both of the fused image frame and the sheared image frame.

In some implementations, the first image frame is a current image frame and the second image frame is a next image frame. In some such implementations, to combine the first image data with the second image data, the one or more processors are configured to, for a given pixel value, sum a first contribution from the first frame with a second contribution from the second image frame. In some such implementations, the first contribution from the first frame is equal to a first weight multiplied by the pixel value for the pixel of the first frame, and the second contribution from the second frame is equal to a second weight multiplied by the pixel value for the pixel of the second frame.

In some implementations, the first and second weights are functions that depend in which line of the display the pixel is located. In some implementations, the one or more processors are further configured to determine a velocity of the visual object. In some such implementations, the first and second weights are functions that depend on the determined velocity.

In some implementations, the one or more processors are further configured to determine a displacement of the visual object between the first image frame and the second image frame. In some such implementations, to apply a shear transformation to the first image data, the one or more processors are configured to, for a given pixel value in position (m, n) of the sheared frame (where m is the column number of the corresponding pixel and n is the scan line or row number of the corresponding pixel), determine the value of the pixel at position (m−k*d, n) of the first frame (where d is the determined displacement of the image data in line n and k is a multiplier), and use the determined pixel value in the first frame at position (m−k*d, n) as the pixel value for position (m, n) of the sheared frame.

In some implementations, to generate the pre-distorted image frame, the one or more processors are configured to sum a first contribution from the fused image frame with a second contribution from the sheared image frame. In some such implementations, the first contribution from the fused image frame is equal to a first weight multiplied by the pixel value for the pixel of the fused image frame, and the second contribution from the sheared image frame is equal to a second weight multiplied by the pixel value for the pixel of the sheared image frame.

According to another innovative aspect of the subject matter described in this disclosure, a device includes means for includes obtaining a first image frame including first image data including image data to be displayed for a moving visual object; means for obtaining a second image frame including second image data including image data to be displayed for the moving visual object; means for combining the first image data with the second image data to generate a fused image frame including fused image data; means for applying a shear transformation to the first image data to generate a sheared image frame including sheared image data; and means for generating a pre-distorted image frame using one or both of the fused image frame and the sheared image frame.

Details of one or more implementations of the subject matter described in this specification are set forth in the accompanying drawings and the description below. Although the examples provided in this disclosure may be described in terms of EMS and MEMS-based displays, the concepts provided herein may apply to other types of displays, such as liquid crystal displays (LCDs), organic light-emitting diode (OLED) displays and field emission displays. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows a depiction of an example computing or display device.

FIG. 2 shows a block diagram depicting example components of a display device that utilizes a dual scanning scheme.

FIG. 3A shows a moving visual object as it is intended to be displayed to a viewer on a display.

FIG. 3B shows a display that utilizes a traditional top-down raster scanning technique without compensating for visual object motion.

FIG. 3C shows a display that utilizes a traditional inside-out dual scanning technique without compensating for visual object motion.

FIG. 3D shows a display that utilizes a traditional top-down-top-down dual scanning technique without visual object motion correction.

FIG. 3E shows a display that utilizes a traditional outside-in dual scanning technique without visual object motion correction.

FIG. 4A shows a depiction of the visual object of FIG. 3A as it is intended to appear to a viewer in a current frame (Frame 1) and a next frame (Frame 2).

FIGS. 4B-4E show the visual object of FIG. 4A at four different time points, t₁, t₂, t₃, and t₄, respectively, within the time the data drivers take to scan a single frame of image data into the display.

FIG. 5A shows a displayed block of text.

FIG. 5B shows distortion to the block of text of FIG. 5A as it is displayed and moving from left to right on a display that utilizes a traditional top-down scanning technique without visual object motion correction.

FIG. 5C shows distortion to the block of text of FIG. 5A as it is displayed and moving from bottom to top on a display that utilizes a traditional top-down scanning technique without visual object motion correction.

FIG. 5D shows distortion to the block of text of FIG. 5A as it is displayed and moving from top to bottom on a display that utilizes a traditional top-down scanning technique without visual object motion correction.

FIG. 6 shows a modified image frame generated by fusing a current frame N and a next frame N+1 in which a visual object is moving from right to left across the display.

FIG. 7 shows a pre-distorted modified image frame generated by shearing a current frame N in which the visual object is moving from right to left across the display.

FIG. 8 shows a modified image frame generated by a combination of fusion and warping operations in which the visual object is moving from right to left across the display.

FIG. 9 shows a flow diagram illustrating a process for generating the modified image frame of FIG. 8 using a combination of fusion and shearing to compensate for distortion of a displayed visual object as it moves across a display.

FIG. 10 shows a flow diagram illustrating a more detailed process for generating the modified image frame of FIG. 8 using a combination of fusion and shearing to compensate for distortion of a displayed visual object as it moves across a display.

FIG. 11A is an isometric view illustration depicting two adjacent interferometric modulator (IMOD) display elements in a series or array of display elements of an IMOD display device.

FIG. 11B is a system block diagram illustrating an electronic device incorporating an IMOD-based display including a three element by three element array of IMOD display elements.

FIGS. 12A and 12B are system block diagrams illustrating a display device that includes a plurality of IMOD display elements.

Like reference numbers and designations in the various drawings indicate like elements.

### DETAILED DESCRIPTION

The disclosed implementations include examples of systems, devices, components, computer products, methods, and techniques for correcting or compensating for visual distortions that may otherwise be perceived by a viewer when a displayed visual object moves across a display. Particular implementations of the subject matter described in this disclosure can be implemented to realize one or more of the following potential advantages. Some implementations are particularly useful or applicable to touchscreen displays. For example, some implementations compensate or pre-correct (hereinafter “compensate,” “correct,” “pre-correct,” and “pre-distort” may be used interchangeably) for visual distortions or “artifacts” that can otherwise be perceived by the human eye and brain when a visual object is moving across the display. Such compensation can enable the viewer to view the moving visual object as intended. For example, some implementations are particularly advantageous in applications and displays in which the visual object is moving across the display with high velocity relative to the scanning speed of the display driver or drivers that scan the image data to the pixels of the display.

Some implementations compensate for distortions that would otherwise be perceived on a display when the visual object's velocity is based on or is a function of a user input. In such cases, the visual object's velocity is thus known—or can be determined—by an image or video processor. For example, some implementations compensate for distortions that would otherwise be perceived on a touchscreen display when the visual object's velocity is based on a user's touch gesture across the touchscreen display. Such compensation can be particularly useful when the velocity of the touch gesture causes the speed of the visual object along a certain direction to be greater than a threshold value relative to the data driver scanning speed. Some implementations are particularly useful when the visual object is a rigid object with one or more straight or substantially straight lines, edges, or boundaries. For example, a visual object with straight lines can be an icon or other image the user is “dragging” or otherwise moving or manipulating across the display. As another example, a visual object with a substantially straight boundary can include a page, paragraph, or body of text that the user is scrolling, paging, or panning through. Some implementations are particularly useful when the leading edge of the moving visual object is oriented perpendicularly to the visual object's motion, and parallel with the scan direction. For example, some such implementations are particularly useful when the leading edge of the moving visual object is oriented vertically, the visual object is moving horizontally, and the scan direction is top-to-bottom or bottom-to-top (a “vertical” scan direction).

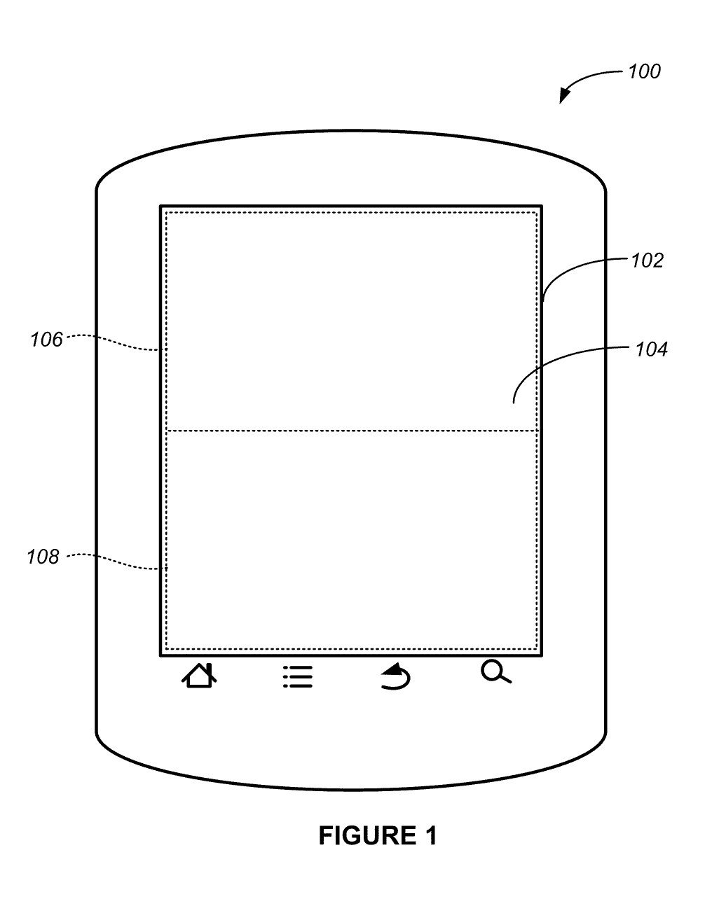

FIG. 1 shows a depiction of an example computing or display device 100. The device 100 can be configured in a variety of forms and to perform a variety of functions according to a variety of applications. In some implementations, the device 100 is a handheld computing device or mobile electronic device having a display 102. In some such implementations, the device 100 can be a digital e-book reader, a mobile handset, a smartphone, a tablet computer, a smartbook device, a netbook computer, or a multimedia device such as an mp3 player. For example, in some implementations, the example display device 100 depicted in FIG. 1 can be configured as an e-book reader. In other implementations, the device 100 can be a laptop computer, a desktop computer, or a general display monitor.

The display 102 can include any suitable display screen technology. For example, the display 102 can be a Mirasol display, an IMOD-based display, an LCD display, or an LED display. In some implementations, the display 102 can generally be configured to display a graphical user interface (GUI) that facilitates interaction between a user of the device 100 and the operating system and other applications executing (or “running”) on the device 100. For example, the GUI may generally present programs, files, and operational options with graphical images. The graphical images may include, for example, windows, fields, dialog boxes, menus, other text, icons, buttons, cursors, scroll bars, among other presentations. During operation of the device 100, the user (hereinafter “user” and “viewer” may be used interchangeably) can select, activate, or manipulate various graphical images (hereinafter also referred to as “visual objects”) displayed on the display 102 to initiate functions associated with the visual object or to otherwise manipulate the visual object.

In some implementations, the device 100 includes one or more user input devices that are operatively coupled to the processor. In some implementations, the device 100 includes a touchscreen 104 in communication with a touchscreen controller and a touchscreen interface. Generally, the touchscreen or other input devices are configured to transfer data, commands, and responses from the outside world into the device 100. For example, the input devices may be used to move a cursor, icon, or other visual object, to navigate menus, and to make selections with respect to the GUI on the display 102. In some implementations, the input devices, such as touchscreen 104, can be used to perform other operations including paging, scrolling, panning, dragging, “flicking,” “flinging,” and zooming, among other possibilities. Other input devices include buttons or keys, computer “mice,” trackballs, touchpads, and joysticks, among others.

The touchscreen 104 is generally configured to recognize the touch and position (among other possible attributes) of a “touch event” on or over the display 102. The processor, alone or in conjunction with other components including the touchscreen 104, then interprets the touch event and executes one or more instructions to perform an action or actions based on the touch event. In some implementations, the touchscreen 104 is configured to sense and distinguish between multiple touches, different magnitudes of touches, as well as the velocity (e.g., speed and direction) or acceleration of a touch as one or more fingers (or a stylus or other suitable object) are moved across or over the touchscreen 104.

The touchscreen 104 can generally include a transparent touch panel with a touch sensitive surface. For example, the touch panel is generally positioned in front of the display 102 such that the touch sensitive surface covers most or all of the viewable area of the display 102. In some other implementations, the touchscreen 104 can be integrated or manufactured with the display 102. The display 102 and touchscreen 104 may collectively be referred to herein as a “touchscreen display.” In various implementations, the touchscreen 104 can utilize any suitable touchscreen technology incorporating one or more of a variety of sensing technologies. For example, the touchscreen 104 may incorporate one or more of capacitive sensing, resistive sensing, optical (e.g., infrared (IR)) sensing, surface acoustic wave sensing, and pressure sensing. In some implementations, the touchscreen 104 can be configured to recognize near-field or other gestures applied over the touchscreen 104; that is, the touchscreen 104 can be configured to sense gestures applied over the touchscreen 104 that do not necessarily physically or directly contact the surface of the touchscreen 104. Thus, for purposes of some implementations herein, touch gestures include gestures that are sensed by a touchscreen or other sensing device regardless of whether or not the gestures physically or directly contact the sensing device.

In some implementations, the touchscreen 104 registers touch events, generates signals in response to the registered touch events, and sends these signals to a touchscreen controller. The touchscreen controller then processes these signals and sends the processed data to the processor. In some implementations, the functionality of the touchscreen controller can be incorporated into or integrated with the processor. For example, the processor can be configured to receive touch event signals from the touchscreen 104 and to process or translate these signals into computer input events.

In some implementations, the touchscreen 104 is capable of recognizing multiple touch events that occur at different locations on the touch sensitive surface of the touchscreen 104 at the same or similar time; that is, the touchscreen allows for multiple contact points or “touch points” to be tracked simultaneously. In some implementations, the touchscreen 104 generates separate tracking signals for each touch point on the touchscreen 104 at the same time. Such a touchscreen may be referred to as a “multi-touch” touchscreen.

In some implementations, the device 100 is operable to recognize gestures applied to the touchscreen 104 and to control aspects of the device 100 based on the gestures. For example, a gesture may be defined as a stylized single or multi-point touch event interaction with the touchscreen 104 that is mapped to one or more specific computing operations. As described, the gestures may be made through various hand and, more particularly, finger motions. The touchscreen 104 receives the gestures and the processor executes instructions to carry out operations associated with the gestures. In some implementations, a memory block of the device 100 includes a gestural operation program and an associated gesture library, which may be a part of the operating system or a separate application. The gestural operation program generally includes a set of instructions that recognizes the occurrence of gestures and informs the processor what instructions to execute or actions to perform in response to the gestures. In some implementations, for example, when a user performs one or more gestures on touchscreen 104, the touchscreen 104 relays gesture information to the processor, which, using and executing instructions from the memory block, including the gestural operation program, interprets the gestures and controls different components of the device 100 based on the gestures. For example, the gestures may be identified as commands for performing actions in applications stored in the memory block, modifying or manipulating visual objects displayed by display 102, and modifying data stored in the memory block. For example, the gestures may initiate commands associated with dragging, flicking, flinging, scrolling, paging, panning, zooming, rotating, and sizing. Additionally, the commands also may be associated with launching a particular program or application, opening a file or document, viewing a menu, viewing a video, making a selection, or executing other instructions.

In some implementations, the device 100, and particularly the touchscreen 104 and the processor, is/are configured to immediately recognize the gestures applied to the touchscreen 104 such that actions associated with the gestures can be implemented at the same time (or substantially the same time as perceived by a viewer) as the gesture. That is, the gesture and the corresponding action occur effectively simultaneously. In some implementations, a visual object can be continuously manipulated based on the gesture applied to the touchscreen 104. That is, there may be a direct relationship between a gesture being applied to the touchscreen 104 and the visual object displayed by the display 102. For example, during a scrolling gesture, the visual object (such as text) displayed on the display 102 moves with the associated gesture (either in the same or the opposite direction for example); that is, with the finger or other input across the touchscreen 104. As another example, during a dragging operation, the visual object (such as an icon, picture, or other image) being dragged moves across the display based on the velocity of the gesture. However, it some implementations, a visual object may continue to move after the gesture has ended. For example, during some scrolling operations, or during a flinging or flicking operation, the visual object's velocity and acceleration can be based on the velocity and acceleration associated with the gesture and may continue to move after the gesture has ceased based on the velocity or acceleration of the previously applied gesture. In such cases, the gesture can be said to have imparted inertia to the visual object's motion.

There are several ways to display images on a display, such as those described above, including both static images and moving images (as used herein, image frames and video frames will be used interchangeably and image data and video data will be used interchangeably). In some implementations, an image or video processor of the device 100 receives image data to be displayed in the form of frames of data. For example, in a progressive display scheme, each frame can include image data for all the pixels of the display. The processor then sends the image data to a display driver of the display device 100 that then transfers or “writes” the image data to the array of pixels in a process typically referred to as “scanning” In a typical matrix addressing scheme, to scan a particular pixel of the display, the display driver sends a control signal to the respective column of the display 102 in the form of a column voltage signal, and to the respective row of the display 102 in the form of a row select voltage signal. In some implementations, each column voltage signal can be applied to an entire column of display elements at one time. Similarly, in some implementations, each row select voltage signal can be applied to an entire row of display elements at one time. The data scanned, written, or latched (hereinafter used interchangeably) into to each individual pixel depends on the column voltage signal and the row select signal that the pixel is coupled with, and in some implementations, to the data previously written and stored in the pixel.

In a traditional raster scanning technique, when displaying a new frame (a “frame update”), a display driver scans each individual row or “scan line” of the display from one end of the line to the other (e.g., from left to right) starting at the top of the display and continuing sequentially down the display ending at the bottom of the display. Conventionally, the first or top row is referred to as row “0.” Thus, for a display having 768 rows, the last or bottom row is row 767. The total time to write an image frame to a display utilizing this scheme can then generally be the sum of the individual times it takes to scan the image data into the each line of pixels. For example, for a display having 768 rows where each row takes 0.05 milliseconds (ms) to scan, the total time it takes to write an entire frame's worth of image data to the display can be 768*0.05=38.4 ms.

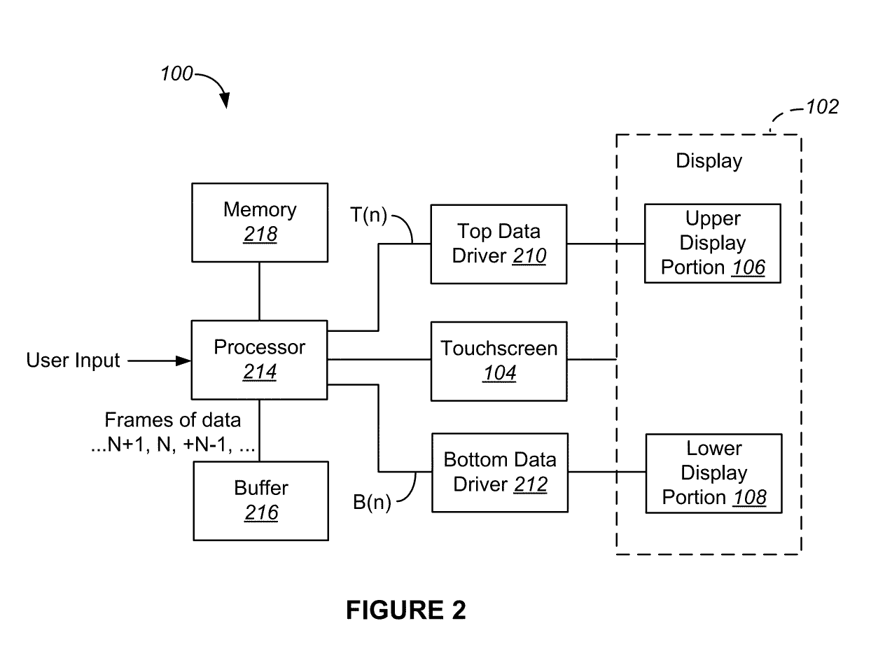

The time it takes to write an image frame to a display can be shortened using a dual scan scheme. Some implementations of display device 100 utilize a dual scan scheme. FIG. 2 shows a block diagram depicting example components of a display device 100 that utilizes a dual scanning scheme. In some implementations, the display device 100 includes two data drivers: a “top” data driver 210 is generally dedicated to an upper half 106 of the display 102 and a “bottom” data driver 212 is generally dedicated to a lower half 108 of the display 102. This allows a scan line in the upper half 106 of the display 102 to be scanned in parallel with the scanning of a scan line in the lower half 108. Effectively, a single display 102 is formed from two independently-controlled display portions, one dedicated to the upper half—106—of the image to be displayed and one dedicated to the lower half—108—of the image to be displayed. Using such a scheme, the time required for a frame update can be reduced by a factor of 2.

There are a number of similar dual scan scheme techniques. For example, in an inside-out dual scan scheme, each data driver first scans the centermost line of the respective display portion and then proceeds sequentially outward from the center to the top or bottom, respectively, depending on whether the data driver is responsible for updating the top half 106 or the bottom half 108 of the display. For example, in a display 102 having 768 rows, the top data driver 210 would start at row 383 and would scan sequentially upward to row 0, while the bottom data driver 212 would start at row 384 and would scan sequentially downward to row 767.

In other dual scan schemes, the top and bottom data drivers 210 and 212 can be configured to scan according to different schemes. For example, in an outside-in dual scan scheme, each data driver first scans the outermost line of the respective display portion and then proceeds sequentially inward from the top or bottom, respectively, to the center depending on whether the data driver is responsible for updating the top half 106 or the bottom half 108 of the display 102. For example, in a display 102 having 768 rows, the top data driver 210 would start at row 0 and would scan sequentially downward to row 383, while the bottom data driver 212 would start at row 767 and would scan sequentially upward to row 384. As another example, both the top data driver 210 and the bottom data driver 212 can be configured to scan in the same direction, such as from the top to the bottom of the respective portions of the display 102 (a “top-down-top-down” dual scan scheme). That is, the top data driver 210 scans sequentially downward from row 0 to row 383 while the bottom data driver 212 scans sequentially downward from row 384 to row 767.

As described above, some implementations are particularly useful or applicable to display devices 100 that utilize touchscreens 104. For example, some implementations compensate or pre-correct for distortions or other visual artifacts that can otherwise be perceived by the human eye when a visual object is moving across the display 102. As is also described above, some implementations are particularly advantageous in applications and displays 100 in which the visual object is moving across the display 102 with high velocity relative to the scanning speed of the display driver—or drivers 210 and 212—that scan the image data to the pixels or other display elements of the display 102.

Some implementations compensate for distortions that can otherwise be perceived on the display 102 when the visual object's velocity is based on or is a function of a user input—such as a touch event or touch gesture—and is thus known by, or can be determined by, a processor 214. For example, some implementations compensate for distortions that would otherwise be perceived on the display 102 when the visual object's velocity is based on a user's touch gesture across the touchscreen 104 over the display 102. Such compensation can be particularly useful when the velocity of the touch gesture causes the speed of the visual object along a certain direction to be greater than a threshold value relative to the scanning speed of the data drivers 210 and 212. Some implementations are particularly useful when the visual object is a rigid object with one or more straight or substantially straight lines, edges, or boundaries. For example, a visual object with straight lines can be an icon or other image the user is “dragging” or otherwise moving across the display 102. As another example, a visual object with a substantially straight boundary can include a page, paragraph, or body of text the user is scrolling, paging, or panning through. Some implementations are particularly useful when the leading edge of the moving visual object is oriented perpendicularly to the visual object's motion and parallel with the scan direction. For example, some such implementations are particularly useful when the leading edge of the moving visual object is oriented vertically, the visual object is moving horizontally, and the scan direction is top-to-bottom or bottom-to-top (a “vertical” scan direction).

In some implementations, the processor 214 is a single processor or chip that includes the functionality of the processor (and/or touchscreen controller) described above with reference to the touchscreen 104, the functionality of the image or video processor described above that sends data to the display drivers 210 and 212, as well as the functionality to perform operations associated with one or more implementations described in this disclosure. In some other implementations, processor 214 can include a plurality of processors each committed, or primarily dedicated to, certain functionalities or components. For example, such functionalities may include processing user inputs, interpreting touch gestures, determining motion vector information (e.g., direction, velocity, and acceleration for visual objects), performing calculations associated with such motion vector information, generating image frames, receiving image frames, buffering image frames, modifying image frames, and transmitting image frames to the display drivers 210 and 212.

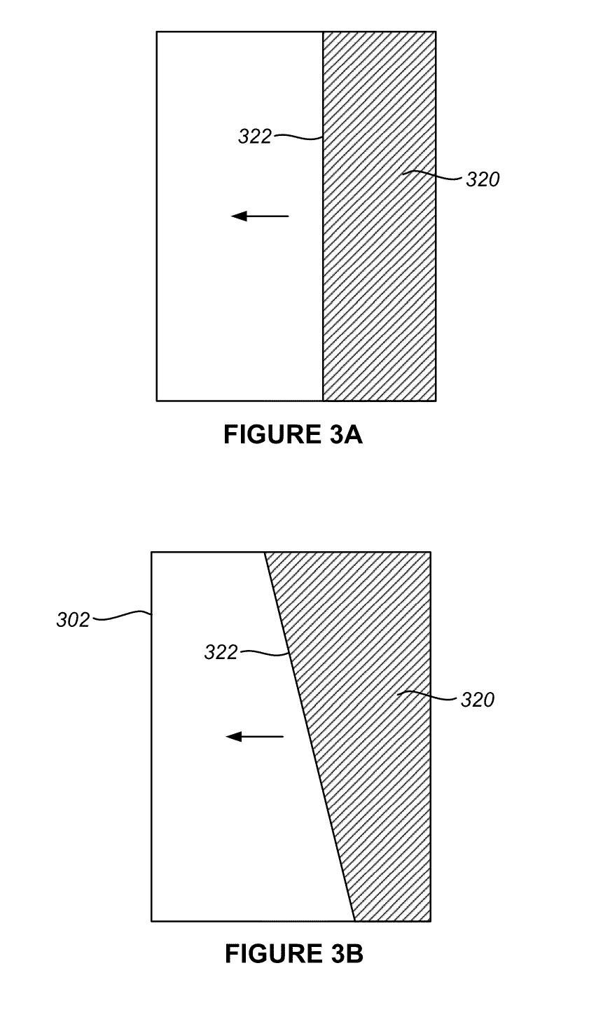

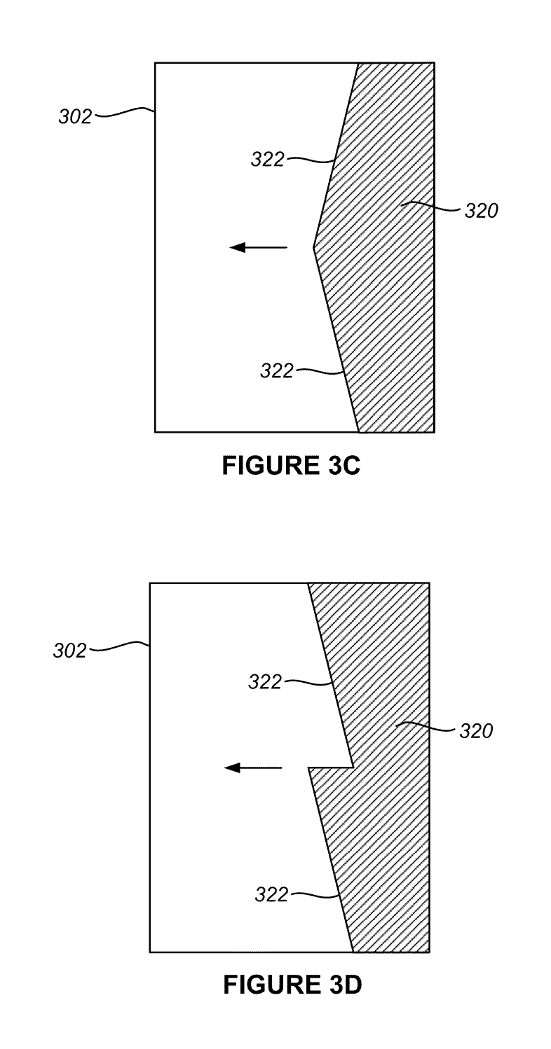

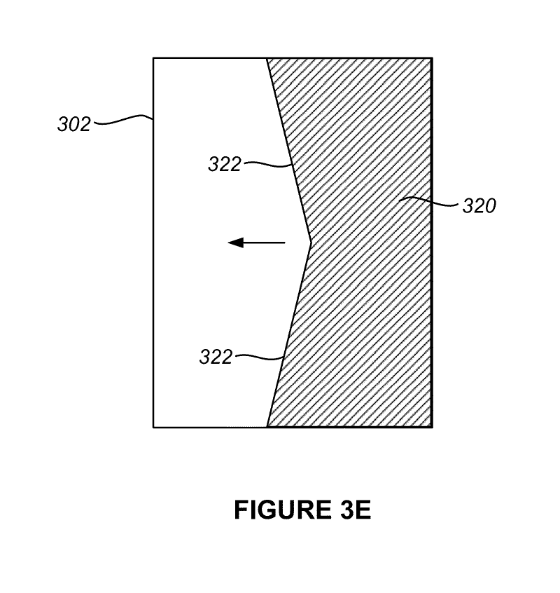

FIGS. 3A-3E demonstrate how visual distortion may appear when a visual object moves across a display. FIG. 3A shows a moving visual object 320 as it is intended to be displayed to a viewer on a display 302. FIGS. 3B-3E show the visual object 320 of FIG. 3A as it appears on the display 302 without compensating for visual object motion. For didactic purposes, the visual object is a simple dark rectangle 320 having a “left” edge 322. The visual object 320 is moving from right to left across the display 302 as indicated by the arrow. For example, the visual object 320 can be moving left as a result of a pan, scroll, flick or fling gesture (e.g., a flick to the right initiating a pan to the left).

FIG. 3B shows a display 302 that utilizes a traditional top-down raster scanning technique without compensating for visual object motion. As FIG. 3B depicts, because the new image data is written sequentially downward from the top line to the bottom line, the top of the edge 322 appears to lead the bottom of the edge 322 as the visual object 320 moves across the display resulting in a “tilted” appearance.

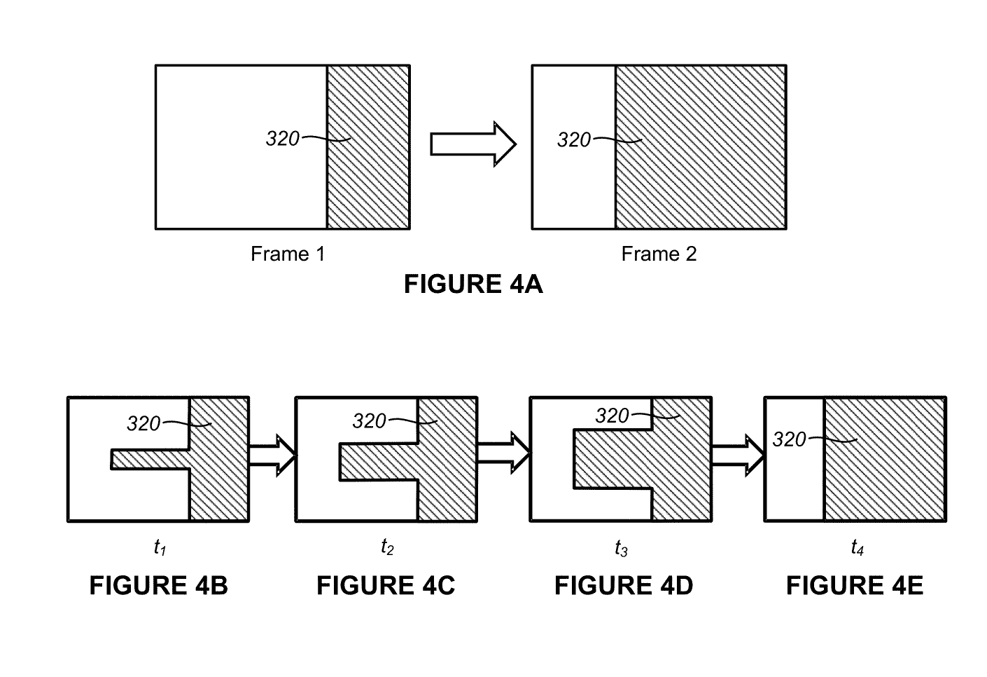

FIG. 3C shows a display 302 that utilizes a traditional inside-out dual scanning technique without compensating for visual object motion. As FIG. 3C depicts, because the new image data is written inside-out with two data drivers scanning simultaneously, the middle of the edge 322 appears to lead the top and the bottom of the edge 322 as the visual object 320 moves across the display resulting in an “arrow-like” appearance. More specifically, FIG. 4A shows a depiction of the visual object 320 of FIG. 3A as it is intended to appear to a viewer in a current frame (Frame 1) and a next frame (Frame 2). As described above, because the display uses a traditional inside-out dual scanning technique, the center lines (e.g., lines 383 and 384 of a 768 line display) are scanned first and the top and bottom lines (e.g., lines 0 and 767, respectively) are scanned last. Because there is a delay (e.g., in some cases 25 ms for a frame rate of 40 Hz) between scanning the center line of a given display half and scanning the outermost line of the display half, the moving visual object 320 (in this case a rectangle) can appear distorted when not compensating for the motion of the visual object 320. For example, FIGS. 4B-4E show the visual object of FIG. 4A at four different time points, t₁, t₂, t₃, and t₄ (e.g., at 6.25 ms after start, at 12.5 ms after start, at 18.75 ms after start, and at 25 ms after start), respectively, within the time (e.g., 25 ms) the data drivers take to scan a single frame of image data into pixels or other display elements of the display 302. As depicted, the centermost lines are scanned first while the outermost lines are scanned last causing the center of the visual object 320 to move left before the outer portions of the visual object. The result is that the human eye and brain average the images of FIG. 4B-4E and perceive an arrow-like shape similar to that shown in FIG. 3C.

FIG. 3D shows a display 302 that utilizes a traditional top-down-top-down dual scanning technique without visual object motion correction. As FIG. 3D depicts, because the new image data is written top-down in each of the upper and lower halves of the display with two data drivers scanning simultaneously, the edge 322 distorts as the visual object 320 moves across the display resulting in a “zig-zag” appearance.

FIG. 3E shows a display 302 that utilizes a traditional outside-in dual scanning technique without visual object motion correction. As FIG. 3E depicts, because the new image data is written outside-in with two data drivers scanning simultaneously, the middle of the edge 322 appears to lag the top and the bottom of the edge 322 as the visual object 320 moves across the display resulting in an “indented” or “reverse-arrow like” appearance.

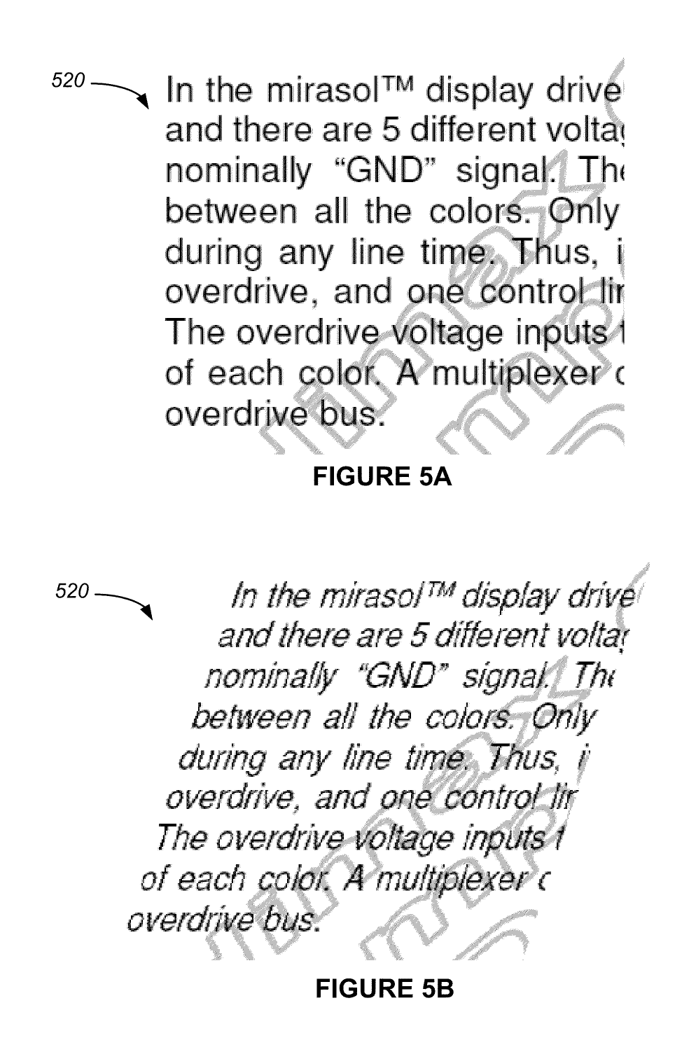

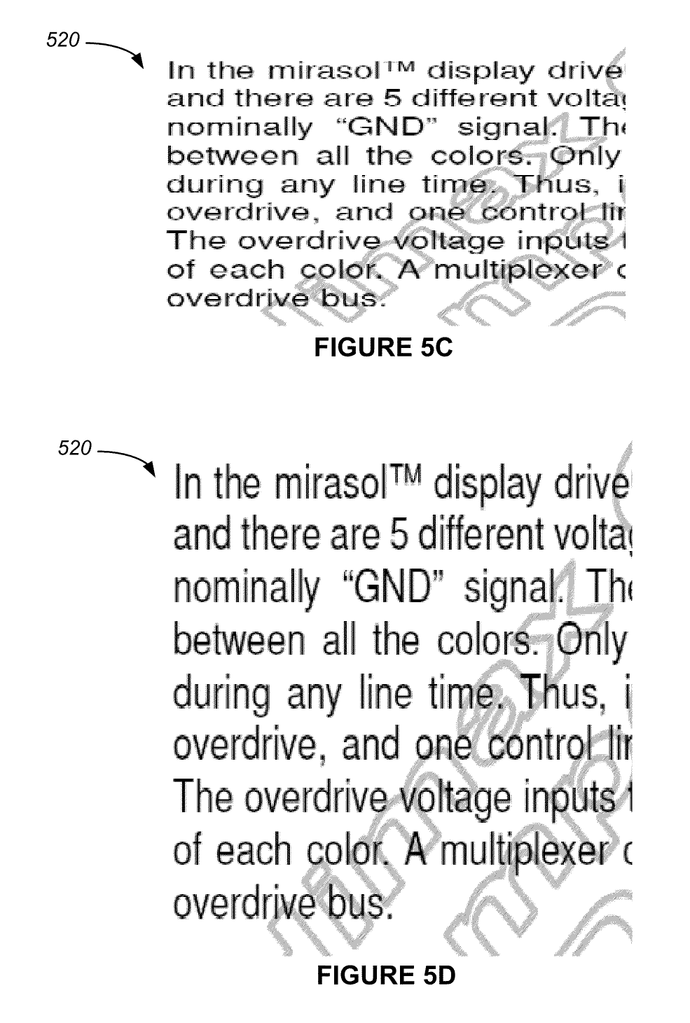

As another example, FIG. 5A shows a displayed block of text. For didactic purposes, FIGS. 5B-5D show exaggerated examples of possible distortion that may be perceived by a viewer in various instances using various displays. FIG. 5B shows distortion to the block of text 520 of FIG. 5A as it is displayed and moving from left to right on a display that utilizes a traditional top-down scanning technique without visual object motion correction. For example, such movement may be the result of a touch gesture applied to the touchscreen 104 that results in a panning of the field of view displayed on the display. FIG. 5C shows distortion to the block of text 520 of FIG. 5A as it is displayed and moving from bottom to top on a display that utilizes a traditional top-down scanning technique without visual object motion correction. For example, such movement may be the result of a touch gesture applied to the touchscreen 104 that results in a scrolling down of the field of view displayed on the display. FIG. 5D shows distortion to the block of text 520 of FIG. 5A as it is displayed and moving from top to bottom on a display that utilizes a traditional top-down scanning technique without visual object motion correction. For example, such movement may be the result of a touch gesture applied to the touchscreen 104 that results in a scrolling up of the field of view displayed on the display.

Referring back to the device 100 of FIGS. 1 and 2, in some implementations, the processor (or processors) 214—in conjunction with one or more of the top display driver 210, the bottom display driver 212, a buffer 216, and a memory 218—use one or more of a “fusion” operation and a “warping” or “shearing” operation to generate or pre-process the image data of an incoming frame to pre-distort or otherwise modify the image data, or a portion of the image data, to generate a modified image frame. In the modified image frame—displayed instead of the current frame—the distortion that would otherwise be perceived as a visual object moves across the display 102 is corrected or compensated for. For example, the visual object may be moving in response to a touch gesture applied to the touchscreen 104. In other implementations or cases, the visual object may be moving in response to input applied to another user input device such as, for example, a mouse, a scroll real, a touch pad, or a key or button. In such implementations, the processor 214 generates the image frames. In still some other implementations or cases, the visual object may be moving according to a predetermined pattern, such as from a video file. In such implementations, the processor 214 receives the image frames from the memory block 218 or the buffer 216.

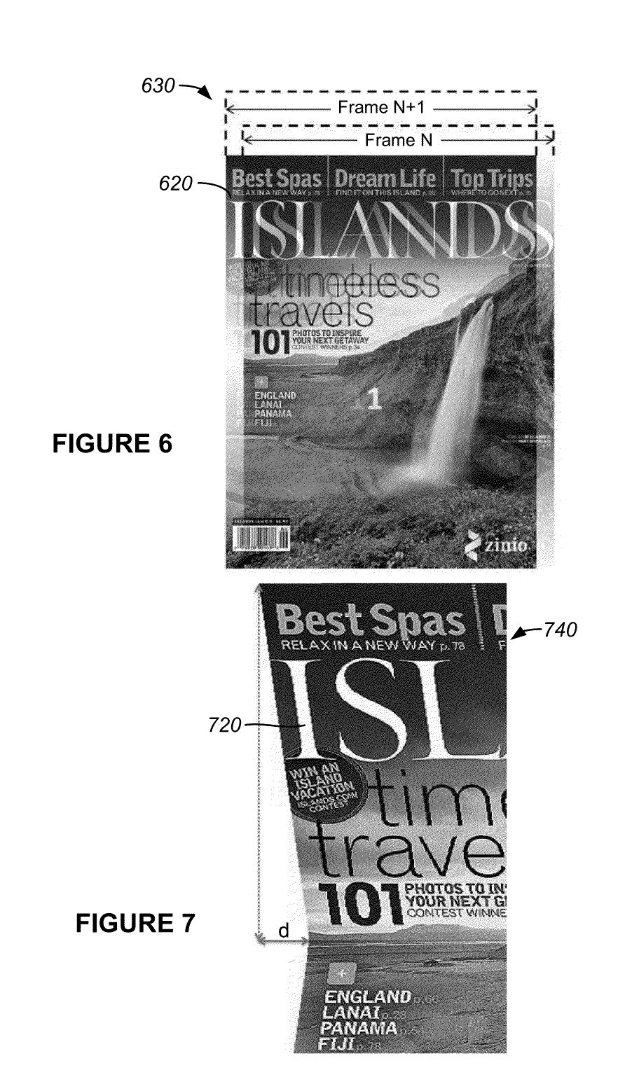

In some implementations, the fusion operation (or simply “fusion”) involves blending image data from a current frame N and a next frame N+1. FIG. 6 shows a modified image frame 630 generated by fusing a current frame N and a next frame N+1 in which a visual object 620 is moving from right to left across the display 102. In the example implementation described with reference to FIG. 6, the visual object 620 is an image of a magazine cover page moving from right to left across the display 102 as a result of, for example, a panning gesture applied on or over the touchscreen 104. In this way, as a result of the processor 214 blending the current frame N and the next frame N+1, when the viewer views the displayed modified image frame 630, the moving visual object 620 will appear to move more smoothly or less “jerky” without distortions that would otherwise be perceived when viewing the visual object 620 as is appears to move across the display 102.

In some implementations, to perform the fusion, the processor 214 can perform a weighted averaging of the image data for certain ones or lines of the pixels from the current frame N and corresponding image data for the next frame N+1. That is, in some implementations, fusion involves line-by-line and pixel-by-pixel blending of image data from the current frame N and the next frame N+1. For example, consider an implementation in which processor 214 and display drivers 210 and 212 utilize an inside-out dual scanning technique. In some implementations, the modified (“fused”) image data that the display drivers 210 and 212 will write to the pixels of display 102 instead of the image data in the current frame N can be determined according to an equation. In some implementations, the processor 214 determines the modified image data according to a weighted equation. As described above, the modified image data can include a contribution from the image data of the next frame N+1, or another frame.

Thus, in some implementations, the buffer 216 enables the use of image data from the current frame N, the next frame N+1, or other frames. Thus, the “current” frame referred to herein is not necessarily the frame that is currently being displayed; rather, the current frame can be a frame that is currently buffered in the buffer 216, for example, along with one or more other frames. For example, the buffer, in some implementations, may store image data for a previous-previous frame N−2, a previous frame N−1, a current frame N, a next frame N+1, and/or a next-next frame N+2, while, for example, the display is actually displaying image data for frame N−3. In some implementations, the buffer 216 also can generally be utilized by the processor 214 to buffer or delay the image data in incoming frames such that the processor 214 has time to read and interpret a touch gesture (or other user input), determine the velocity of the visual object (or displacement between frames), and performed the visual object compensation operations described herein prior to sending modified image data to the top and bottom data drivers 210 and 212.

In some implementations, the equation for the modified (fused) image data T(n) for a given pixel in line n is a linear equation. In some implementations, the equation for the fused image data T(n) for the modified image frame 630 for the top half 106 of the display 102, where there are 768 lines and the top line is line 0, is equation (1) below.

$$T ( n ) = \frac{n}{383} * C ( n ) + \frac{383 - n}{383} * X ( n ) \qquad ( 1 )$$

where C(n) is the value of the image data for a particular pixel in line n of the current frame N and X(n) is the value of the image data for the particular pixel in line n of the next frame N+1. In some implementations, the equation for the fused image data B(n) for the modified image frame 630 for the bottom half 108 of the display 102 is equation (2) below.

$$B ( n ) = \frac{767 - n}{383} * C ( n ) + \frac{n - 384}{383} * X ( n ) \qquad ( 2 )$$

As can be gleaned from the above equations (1) and (2), the fusion ratio—the relative contributions of the current frame and the next frame—can depend on the line position. Additionally, in the described implementation in which the processor 214 and display drivers 210 and 212 utilize an inside-out dual scanning technique, the contribution of the image data for the current frame N can be increased as the center of the display is approached from the top and bottom, respectively. Similarly, the contribution of the image data for the next frame N+1 can be increased as the top and bottom of the display are approached, respectively. In various general implementations, other weighted averaging approaches can be employed. For example, in one general implementation, the fused image data F(n) for the modified image frame can be determined by equation (3) below.

F(n)=α*C(n)+β*X(n) (3)

where α, which may be a function of the line n (and whether the line n is in the top half 106 or bottom half 108), represents the weight applied to the contribution from the current frame and β, which also may be a function of the line n (and whether the line n is in the top half 106 or bottom half 108), represents the weight applied to the contribution from the next frame. Generally, in some implementations, whatever scanning technique is being utilized, the first lines that are scanned for the fused image can have pixel data which depends relatively more on the image data for the current frame, while the last lines that are scanned for the fused image can have pixel data which depends relatively more on the image data for the next frame. In some other implementations, α and β can each be functions of the velocity of the visual object. Additionally, the fusion methods and other methods, including shearing, described herein, can be applied to displays having various numbers of scan lines and using various display technologies, different numbers of data drivers, and different scanning algorithms.

In some other implementations, the processor 214 also can include contributions from a next-next frame N+2, or a previous frame N−1, or a previous-previous frame N−2, among other possible contributions to the modified fused image frame. For example, in some implementations, the processor 214 can calculate modified fused image data to be displayed for a current frame N based on image data for the current frame N and image data (or fused image data) displayed for the previous frame N−1. That is, C(n) can be the value of the image data for a particular pixel in line n of the current frame N while X(n) can be the value of the image data for the particular pixel in line n of the previous frame N−1. In some implementations, X(n) also can represent the value of the modified or fused (or fused and warped) image data for the particular pixel in line n of the previous frame N−1.

In some implementations, the processor 214 and data drivers 210 and 212 are additionally or alternately configured to pre-distort an image by performing a warping or shearing operation (or simply “shearing”). In some implementations, the shearing involves applying a shear transformation to the image data from the current frame N. FIG. 7 shows a pre-distorted modified image frame 730 generated by shearing a current frame N in which the visual object 720 is moving from right to left across the display 102. In the example implementation described with reference to FIG. 7, the visual object 720, like the visual object 620 of FIG. 6, is an image of a magazine cover page moving from right to left across the display 102 as a result of, for example, a panning gesture applied on or over the touchscreen 104. Again, in other implementations or cases, the visual object may be moving in response to input applied to another user input device such as, for example, a mouse, a scroll real, a touch pad, or a key or button.

In the illustrated case and implementation, the visual object 720, as a result of the shearing applied by the processor 214, appears in the modified image frame 740 to be distorted into an indented, reverse arrow like appearance. In this way, when the visual object 720 in the modified image frame 740 is displayed on the display 102, the pre-distortion compensates for the otherwise arrow-like distortion (e.g., like that depicted in FIG. 3C) the visual object 720 would otherwise be perceived as having when moving from right to left across the display 102. That is, such that the visual object 720, when moving, appears as intended without perceived distortion.

In some implementations, the amount of shearing—or the magnitude of displacement of the shear transformation—applied by the processor 214 to the image data of the current frame N depends on the magnitude of the displacement of the visual object 720 from one frame to the next; that is, the amount of shearing depends on the velocity of the visual object. For example, in some implementations, the image data for the modified image frame 740 can be determined by shifting or translating the image data for the current frame. That is, in some implementations, the image data for a pixel to be displayed in line n and column m of the modified image frame is taken from the image data for the pixel in line n and column m-d of the current image frame N. For example, in some implementations, d represents the distance in columns of pixels the visual object 720 moves between frames as determined from the velocity of the visual object calculated as of the current frame N. For example, the shifting of pixel image data (which results in the shearing) may be a function of the displacement determined by the processor 214 and/or the line n in which the pixel is located. For example, because the processor 214 can determine the velocity of the visual object 720 based on the touch gesture or other user input (or from frame comparison or motion vector analysis in some other implementations), the processor 214 can calculate or otherwise determine the distance Δx the visual object 720 moves in a given frame, which can then be translated to a displacement in a number of pixels d. In some cases or implementations, this displacement is the same for each line of the modified image frame in which the visual object 720 is displayed. In some implementations in which a vertical scanning technique is utilized (e.g., top-down or inside-out), only the velocity component of the visual object along a horizontal direction (the “horizontal speed component”)—as opposed to a general velocity direction—is used in the displacement and shearing calculations by the processor 214.

In some other implementations, the image data for the pixels in the two centermost lines (e.g., lines 383 and 384 of a 768 line display) in the warped image frame are pre-distorted or sheared by Δx (d columns) while each other line is sheared by a fraction of Δx. For example, the image data W(m, n) for a pixel in column m and line n in the modified frame can be

W(m,n)=C(m−k*d,n) (4)

where

$$k = ( c * \frac{n}{383} )$$

for the top half of the display and

$$k = ( c * \frac{767 - n}{383} )$$

for the bottom half of the display. In some implementations, c in the expression for k is a constant. In some implementations, the value of c is empirically or theoretically determined to provide the for the best human eye perception of the moving visual object. For example, in one implementation, the value of c is 0.75 such that the pixel values in the centermost two lines of the modified image frame are sheared right by 0.75*d and the outermost two lines of the modified image frame are not sheared at all. In some other implementations, other linear or nonlinear shearing or other distorting equations may be utilized to modify the image data.

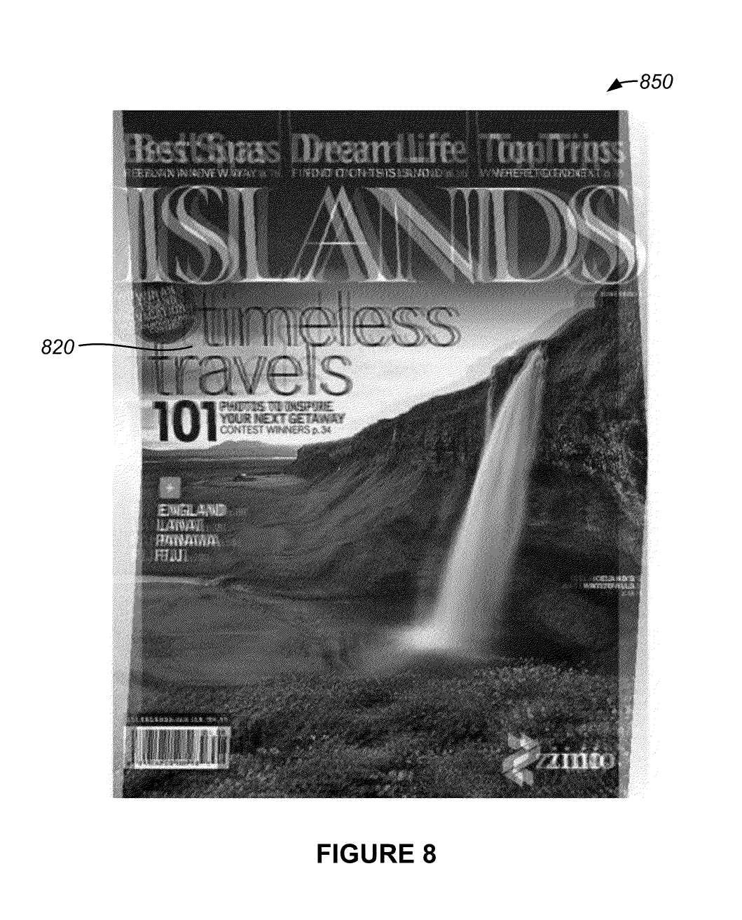

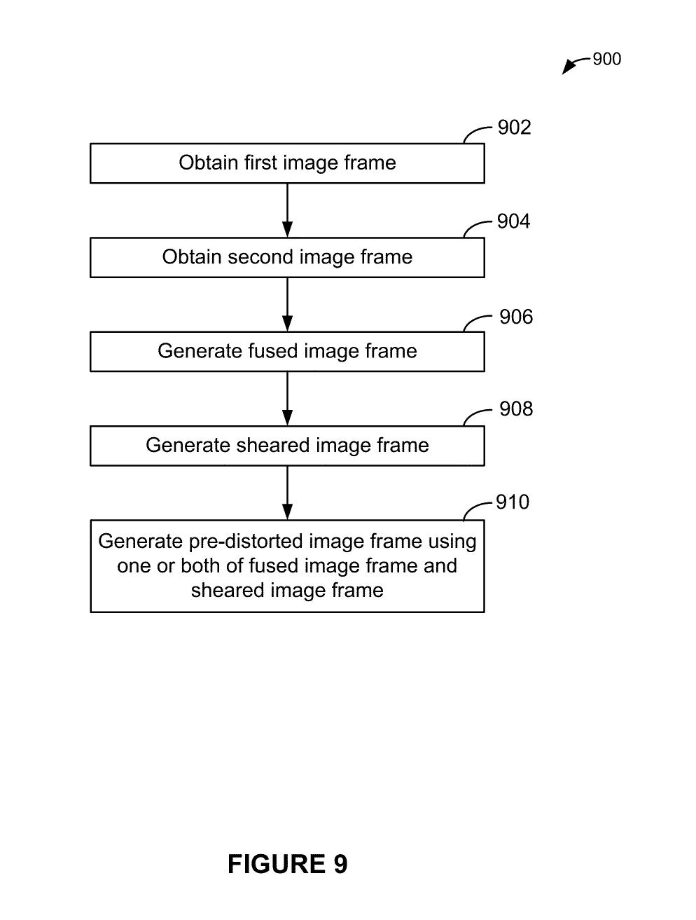

As described above, in some implementations, the processor 214 utilizes a combination of one or both of a fusion operation and a shearing operation, such as those described above with reference to FIGS. 6 and 7, respectively. FIG. 8 shows a modified or pre-distorted image frame 850 generated by a combination of fusion and warping operations in which the visual object 820 is moving from right to left across the display 102. FIG. 9 shows a flow diagram illustrating a process 900 for generating the modified or pre-distorted image frame 850 of FIG. 8 using a combination of one or both of a fusion operation and a shearing operation to compensate for distortion of a displayed visual object 820 as it moves across a display 102. For example, in some implementations, the process 900 begins in block 902 with obtaining a first image frame including first image data. The first image data for the first image frame includes image data to be displayed for the visual object 820. The process 900 proceeds in block 904 with obtaining a second image frame including second image data. The second image data for the second image frame also includes image data to be displayed for the visual object 820 such that a user, when viewing image data from the first and second frames sequentially on a display perceives the visual object as moving on the display. In some implementations, the process 900 proceeds in block 906 with combining the first image data with the second image data to generate a fused image frame including fused image data. In some implementations, the process 900 proceeds in block 908 with applying a shear transformation to the first image data to generate a sheared image frame including sheared image data. It is understood that, in different implementations, block 906 and 908 may both be performed, or only one of block 906 and 908 may be performed. In block 910, the process 900 proceeds with generating a pre-distorted image frame using one or both of the fused image frame and the sheared image frame. Because some implementations, applications, or instances may require only one or the other of a fused image frame or a sheared image frame, in some implementations, one of blocks 906 and 908 may be omitted for a given frame.

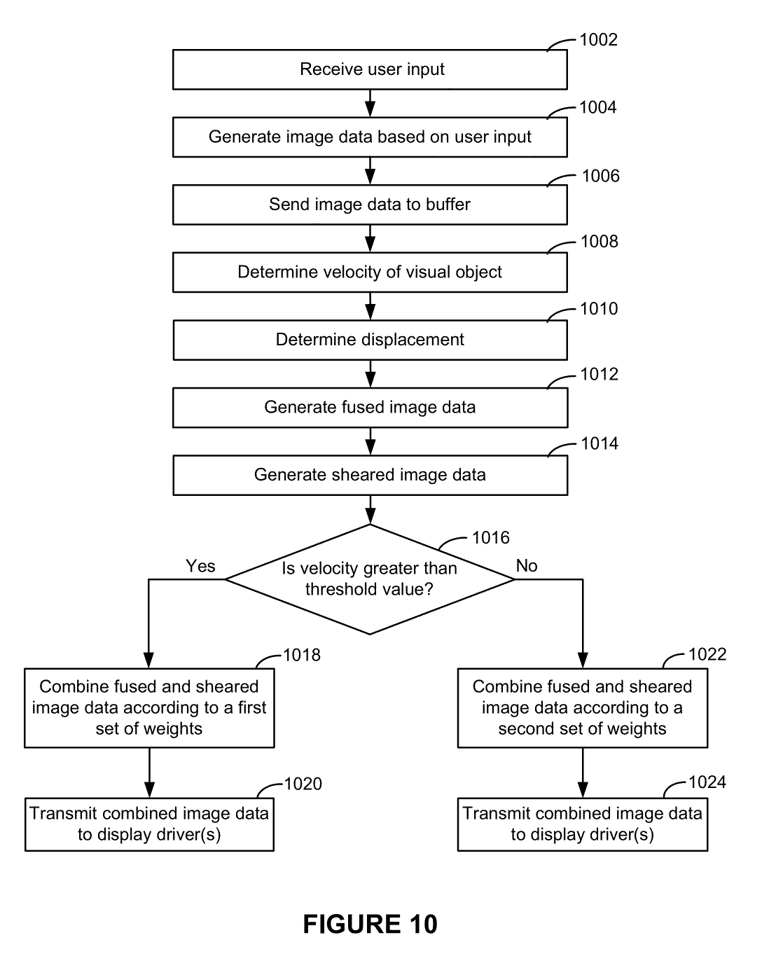

FIG. 10 shows a flow diagram illustrating a more detailed process 1000 for generating the modified or pre-distorted image frame 850 of FIG. 8 using a combination of one or both of a fusion operation and a shearing operation to compensate for distortion of a displayed visual object 820 as it moves across a display 102. For example, in some implementations, the process 1000 begins in block 1002 with the processor 214 receiving a user input. For example, the user input can be a touch event or touch gesture (e.g., a scrolling, panning, flicking, or flinging gesture) applied on or over the touchscreen 104. The processor 214 then generates image data, in block 1004, based on the touch gesture or other user input or previous user input. For example, the processor may generate an image data frame to cause the visual object 820 of FIG. 8 to appear to move across the display 102 when displayed after the previous frames of data. The current image frame N is sent to the buffer 216 in block 1006.

In some such implementations, in block 1008, the processor 214 determines the velocity of the visual object 820 moving, or to be moved, using information from the touchscreen 104 or other user input device. In some other implementations, the processor 214 may be configured to determine the velocity of the visual object 820 using a frame comparison approach or motion vector analysis. In some implementations in which a vertical scanning technique is utilized (e.g., inside-out or top-down), the processor 214 determines only the horizontal speed component of the visual object 820. In one implementation, the processor 214 determines the velocity (or speed) of the moving object 820 in, for example, a number of pixels per millisecond (pixels/ms). In some implementations, based on the velocity determined by the processor 214 in block 1008, the processor calculates or otherwise determines, in block 1010, the intended displacement Δx between the current frame and the next frame. For example, the processor 214 may calculate the displacement along the horizontal direction—along a scan line—in terms of a number of pixels d.

In some implementations, in block 1012, the processor 214 then, using the image frames stored in the buffer 216, performs a fusion operation to generate a fused image frame having fused image data F(n), as described above with reference to FIG. 6 and equations (1), (2), and (3). As described above, in some cases the weights α and β (in equation (3)) also can be functions of the velocity determined in 1008. In some implementations, in block 1014, the processor 214 then, using the displacement d determined in block 1010, performs a shearing operation to generate a sheared image frame having sheared image data W(n), as described above with reference to FIG. 7 and equation (4).

As described above, in some implementations, the processor 214 combines the fused image data F(n) with the sheared image data W(n). In some implementations, the processor 214 combines the fused image data F(n) with the sheared image data W(n) to generate combined pre-distorted image data P(n) according to a weighted linear equation, such as equation (5) below.

P(n)=γ*F(n)+∈*W(n) (5)

where γ represents the weight applied to the fusion contribution and ∈ represents the weight applied to the sheared contribution. In some implementations, the values of γ and ∈ are statically-predetermined. In some other implementations, the values of γ and ∈ are dynamically determined by the processor 214 based on, for example, the velocity determined in block 1008. In various implementations, the values of γ and ∈ can be continuous or discreet functions of the velocity determined in block 908. In still some other implementations, the values of γ and ∈ can be statically-predetermined for various speed ranges or “buckets” of speed values.

In some implementations, in block 1016, the processor 214 compares the velocity determined in block 1008 to a threshold value and determines whether the determined velocity (or the horizontal speed component) is greater than the threshold value. In various implementations, the threshold value can be statically determined (e.g., empirically or subjectively predetermined) or dynamically determined (e.g., based on the current frame rate). For example, in one implementation of a display 102 having a 40 Hz frame rate, the threshold value can be approximately 2 pixels/ms. In some other implementations, the processor 214 can determine the threshold value as the displacement in pixels d determined at block 1010 divided by the frame rate, which, as described below, may change dynamically based on the speed calculated in block 1008. In some implementations, if, at block 1016, the processor 214 determines that the velocity is greater than the threshold value, the processor 214 applies a first set of weights γ=1 and ∈=0 to equation (5) to generate the image data P(n) in block 1018. Thus, the image data P(n) that the processor 214 sends to the display drivers 210 and 214 in block 1020 is the fused image data F(n); that is, P(n) for frame N has no component or contribution from sheared image data W(n). In such implementations, it can sometimes be beneficial to calculate W(n) only after it is determined that the velocity calculated in block 1008 is less than the threshold value.

In some implementations, if, at block 1016, the processor 214 determines that the velocity is less than the threshold value, the processor 214 applies a second set of weights γ=0.5 and E=0.5 to equation (5) to generate the image data P(n) in block 1022. Thus, the image data P(n) that the processor 214 sends to the display drivers 210 and 214 in block 1024 represents equal contributions from the fused image data F(n) and the sheared image data W(n). As described above, in some other implementations, the weights γ and ∈ can be unequal or dynamically or otherwise determined, for example, according to the speed calculated in block 1008. For example, as the speed increases, the value of the weight γ may increase and the value of the weight ∈ may decrease. This is because, according to some implementations, when the speed determined in block 1008 is relatively fast, fusion can work best to minimize visual distortion while, when the speed is moderate to relatively slow, the value of warping in reducing visual distortion increases.

There also may be more ranges (buckets) of speed values in implementations in which the proportions are determined according to such ranges. For example, for speeds under a first threshold value, the values of γ and ∈ may be set to certain fixed values; for speeds above the first threshold value but under a second threshold value, the values of γ and ∈ may be set to certain different fixed values; while for speeds above the second threshold value, the values of γ and ∈ may be set to certain still different values. That is, in such an example implementation, the proportions of the contributions from the fused image data F(n) and the sheared image data W(n) may vary among three proportions based on which one of the three speed ranges (buckets) the speed determined in block 908 falls within.

In some implementations, the numbers, sizes, ranges, or values in or of the buckets can be dynamically computed as the image data is received. In some other implementations, these attributes can be pre-determined and pre-loaded in one or more look-up tables, for example. Such implementations can enable faster processing.

Additionally, in some implementations, the processor 214 can vary the frame update rate based on the speed determined in block 1008 and send the new frame rate to the display drivers 210 and 212. For example, in one implementation, if, at block 1016, the processor 214 determines that the velocity is less than the threshold value, the processor 214 maintains a current normal frame rate (e.g., 20 fps), while, if, at block 1016, the processor 214 determines that the velocity is greater than the threshold value, the processor 214 generates image data and causes the display drivers 210 and 212 to display the image data at a higher frame rate (e.g., 40 fps). In some other such implementations, the threshold value that the processor 214 uses in the comparison to determine whether or not to change or update the frame rate can be a different threshold value than that used to determine the relative contributions of fused and sheared image data. Additionally, in some implementations, any of one or more of the equations above can be dynamically determined or otherwise selectively modified based on the frame rate.

The description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

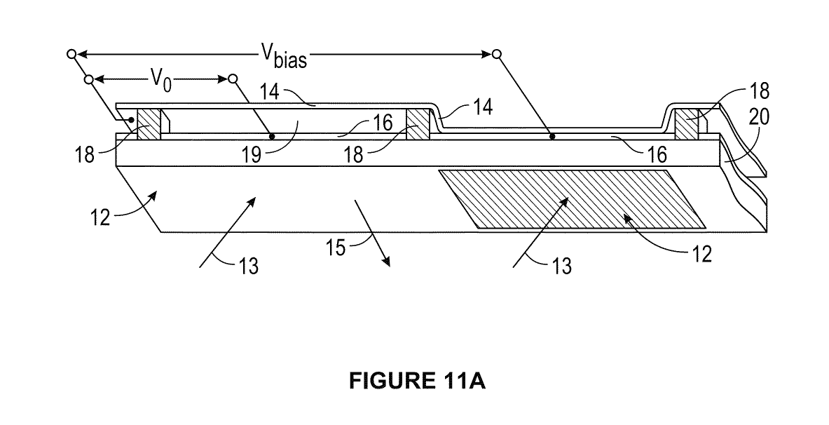

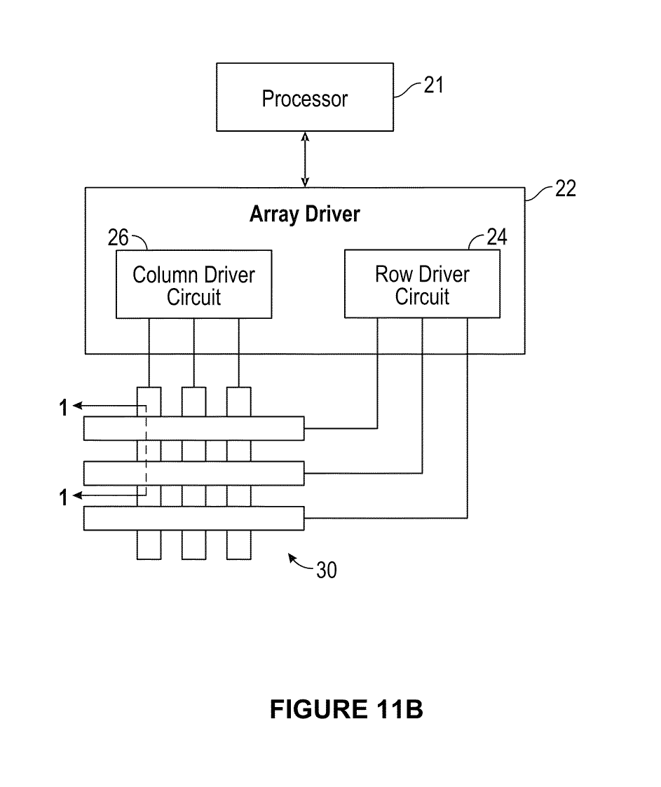

FIG. 11A is an isometric view illustration depicting two adjacent interferometric modulator (IMOD) display elements in a series or array of display elements of an IMOD display device. For example, the IMOD display device can be suitable for use as the display device 100. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved. Although the IMOD display elements illustrated here have only two states, it is understood that some implementations of IMOD display elements can include devices capable of having multiple states, such as, for example, eight color states. In some implementations, the eight color states include white, black, and six other colors (such as, for example, blue, cyan, green, orange, yellow, red). Such multiple-state IMODs are capable of being “relaxed” and “closed” as described above, but are also capable of having, for example, six intermediate states with the movable reflective layer 14 in various intermediate positions between “relaxed” and “closed.”

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 11A includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 11A, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, one implementation of which includes a fixed reflective layer and a movable layer which is partially transmissive and partially reflective, may be configured to be viewed from the opposite side of a substrate as the display elements 12 of FIG. 11A and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 11A, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 11A. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 11B is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application. In some implementations, the processor 21 is the same as, or a part of the same chip or package as, the processor 214 described above. In some other implementations, the processors 21 and 214 are separate and distinct (although they may be communicatively coupled). As described above, the processor 214 can be a single processor or chip that includes the functionality of the processor (and/or touchscreen controller) described above with reference to the touchscreen 104, the functionality of the image or video processor described above that sends data to the display drivers 210 and 212, as well as the functionality to perform operations associated with one or more implementations described in this disclosure, including the functionality of processor 21. In some other implementations, processor 214 can include a plurality of processors (including a separate processor 21) each committed, or primarily dedicated to, certain functionalities or components.

As described above, the processor 21 (or 214, see FIG. 2) can be configured to communicate with an array driver 22. For example, the array driver 22 can be suitable for use as the top data driver 210 (see FIG. 2) or the bottom data driver 212 (see FIG. 2) described above. The array driver 22 can include a row driver circuit 24 and a column driver circuit 26 that provide signals to, for example a display array or panel 30. For example, the display array or panel 30 can be suitable for use as the display 102 (see FIG. 2) described above. The cross section of the IMOD display device illustrated in FIG. 11A is shown by the lines 1-1 in FIG. 11B. Although FIG. 11B illustrates a 3×3 array of IMOD display elements for the sake of clarity, the display array 30 may contain a very large number of IMOD display elements, and may have a different number of IMOD display elements in rows than in columns, and vice versa.

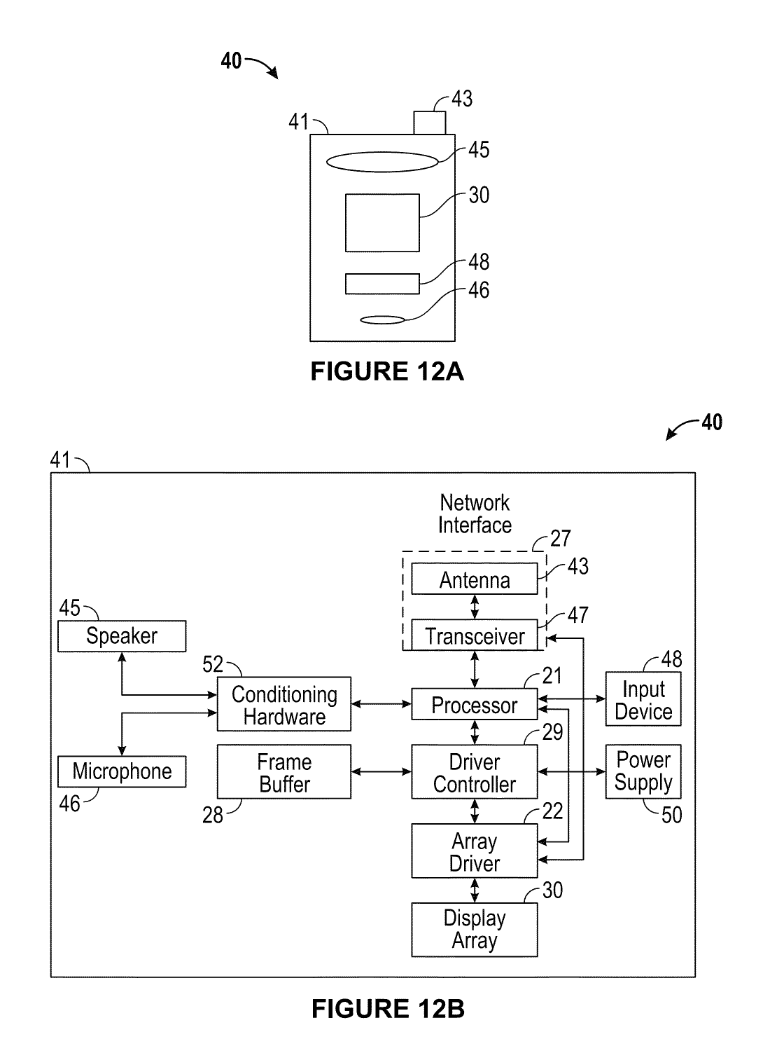

FIGS. 12A and 12B are system block diagrams illustrating a display device 40 that includes a plurality of IMOD display elements. For example, the display device can be suitable for use as display device 100 described above. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 (which can be or which can include the touchscreen 104 described above) and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

Some of the components of the display device 40 are schematically illustrated in FIG. 12A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. For example, the frame buffer 28 can be suitable for use as the buffer 216 described above. One or more elements in the display device 40, including elements not specifically depicted in FIG. 12A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.8A, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 (or 214, see FIG. 2) can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the pre-distorted image data generated by the processor 21 (or 214, see FIG. 2) either directly from the processor 21 (or 214, see FIG. 2) or from the frame buffer 28 (or buffer 216, see FIG. 2) and can re-format the pre-distorted image data appropriately for high speed transmission to the array driver 22. In some implementations, the driver controller 29 can re-format the pre-distorted image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method comprising:
obtaining, by one or more processors, a first image frame including first image data, the first image data for the first image frame including image data to be displayed for a moving visual object;
obtaining, by the one or more processors, a second image frame including second image data, the second image data for the second image frame including image data to be displayed for the moving visual object;
performing one or both of
combining, by the one or more processors, the first image data with the second image data to generate a fused image frame including fused image data; and
applying, by the one or more processors, a shear transformation to the first image data to generate a sheared image frame including sheared image data; and
generating a pre-distorted image frame using one or both of the fused image frame and the sheared image frame.

2. The method of claim 1, wherein the first image frame is a current image frame and the second image frame is a next image frame.

3. The method of claim 1, wherein:
combining the first image data with the second image data includes, for a given pixel value, summing a first contribution from the first frame with a second contribution from the second image frame;
the first contribution from the first frame is equal to a first weight multiplied by the pixel value for the pixel of the first frame; and
the second contribution from the second frame is equal to a second weight multiplied by the pixel value for the pixel of the second frame.

4. The method of claim 3, wherein the first and second weights are functions that depend in which line of the display the pixel is located.

5. The method of claim 4, further comprising:
determining a velocity of the visual object, wherein the first and second weights are functions that depend on the determined velocity.

6. The method of claim 1, further comprising:
determining a displacement of the visual object between the first image frame and the second image frame.

7. The method of claim 6, wherein applying a shear transformation to the first image data includes, for a given pixel value in position (m, n) of the sheared frame, where m is the column number of the corresponding pixel and n is the scan line or row number of the corresponding pixel:
determining the value of the pixel at position (m−k*d, n) of the first frame, where d is the determined displacement of the image data in line n and k is a multiplier; and
using the determined pixel value in the first frame at position (m−k*d, n) as the pixel value for position (m, n) of the sheared frame.

8. The method of claim 1, wherein:
generating the pre-distorted image frame includes summing a first contribution from the fused image frame with a second contribution from the sheared image frame;
the first contribution from the fused image frame is equal to a first weight multiplied by the pixel value for the pixel of the fused image frame; and
the second contribution from the sheared image frame is equal to a second weight multiplied by the pixel value for the pixel of the sheared image frame.

9. The method of claim 8, further comprising:
determining a velocity of the visual object, wherein the first and second weights are functions that depend on the determined velocity.

10. The method of claim 9, further comprising:
adjusting a frame rate of the displayed image frames based on the determined velocity.

11. The method of claim 1, further comprising:
receiving a user input, and wherein the visual object is moving in response to the user input.

12. The method of claim 11, wherein the user input is a touch gesture applied to a touchscreen of the device housing the display.

13. The method of claim 11, wherein the velocity or displacement of the visual object is determined based on the user input.

14. The method of claim 11, wherein obtaining the first and second image frames includes generating, by the one or more processors, the first and second image frames based at least in part on the user input.

15. The method of claim 1, further comprising:
transmitting, by the one or more processors, the pre-distorted image frame to one or more display drivers; and
scanning, by the one or more processors, the pre-distorted image data into the pixels or other display elements of the display.

16. The method of claim 15, wherein the scanning is accomplished by two display drivers that collectively utilize an inside-out dual scanning technique.

17. A device comprising,
a display;
one or more display drivers for scanning lines of the display based on image data in image frames received by the display drivers;
a buffer for buffering image frames; and
one or more processors configured to:
obtain a first image frame including first image data, the first image data for the first image frame including image data to be displayed for a moving visual object;
obtain a second image frame including second image data, the second image data for the second image frame including image data to be displayed for the moving visual object;
combine the first image data with the second image data to generate a fused image frame including fused image data;
apply a shear transformation to the first image data to generate a sheared image frame including sheared image data; and
generate a pre-distorted image frame using one or both of the fused image frame and the sheared image frame.

18. The device of claim 17, wherein the first image frame is a current image frame and the second image frame is a next image frame.

19. The device of claim 17, wherein:
to combine the first image data with the second image data, the one or more processors are configured to, for a given pixel value, sum a first contribution from the first frame with a second contribution from the second image frame;
the first contribution from the first frame is equal to a first weight multiplied by the pixel value for the pixel of the first frame; and
the second contribution from the second frame is equal to a second weight multiplied by the pixel value for the pixel of the second frame.

20. The device of claim 19, wherein the first and second weights are functions that depend in which line of the display the pixel is located.

21. The device of claim 20, wherein the one or more processors are further configured to determine a velocity of the visual object, and wherein the first and second weights are functions that depend on the determined velocity.

22. The device of claim 17, wherein the one or more processors are further configured to determine a displacement of the visual object between the first image frame and the second image frame.

23. The device of claim 22, wherein, in order to apply the shear transformation to the first image data, the one or more processors are configured to, for a given pixel value in position (m, n) of the sheared frame, where m is the column number of the corresponding pixel and n is the scan line or row number of the corresponding pixel:
determine the value of the pixel at position (m−k*d, n) of the first frame, where d is the determined displacement of the image data in line n and k is a multiplier; and
use the determined pixel value in the first frame at position (m−k*d, n) as the pixel value for position (m, n) of the sheared frame.

24. The device of claim 17, wherein:
to generate the pre-distorted image frame, the one or more processors are configured to sum a first contribution from the fused image frame with a second contribution from the sheared image frame;
the first contribution from the fused image frame is equal to a first weight multiplied by the pixel value for the pixel of the fused image frame; and
the second contribution from the sheared image frame is equal to a second weight multiplied by the pixel value for the pixel of the sheared image frame.

25. The device of claim 24, wherein the one or more processors are further configured to determine a velocity of the visual object, wherein the first and second weights are functions that depend on the determined velocity.

26. The device of claim 25, wherein the one or more processors are further configured to adjust a frame rate of the displayed image frames based on the determined velocity.

27. The device of claim 17, further comprising:
one or more user input devices configured to detect user input, and wherein the visual object is moving in response to the user input.

28. The device of claim 27, further comprising:
a touchscreen, and wherein the user input is a touch gesture applied to the touchscreen.

29. The device of claim 27, wherein the one or more processors determine the velocity or displacement of the visual object based on the user input.

30. The device of claim 27, wherein to obtain the first and second image frames, the one or more processors are configured to generate the first and second image frames based at least in part on the user input.

31. The device of claim 17, wherein the one or more processors are further configured to transmit the pre-distorted image frame to the one or more display drivers, and wherein the one or more display drivers scan the pre-distorted image data into the pixels or other display elements of the display.

32. The device of claim 31, wherein there are two display drivers that collectively utilize an inside-out dual scanning technique.

33. A device comprising:
means for obtaining a first image frame including first image data, the first image data for the first image frame including image data to be displayed for a moving visual object;
means for obtaining a second image frame including second image data, the second image data for the second image frame including image data to be displayed for the moving visual object;
means for combining the first image data with the second image data to generate a fused image frame including fused image data;
means for applying a shear transformation to the first image data to generate a sheared image frame including sheared image data; and
means for generating a pre-distorted image frame using one or both of the fused image frame and the sheared image frame.
